(19) United States
(12) Patent Application Publication
(10) Pub. No.: US 2009/0099680 A1
(43) Pub. Date: Apr. 16, 2009

(54) Manufacturing equipment

(75) Inventor: Hirokazu Usui, Nagoya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/285,474

(22) Filed: Oct. 7, 2008

(30) Foreign Application Priority Data
Oct. 10, 2007 (JP) 2007-264737

(51) Int. Cl. G06F 19/00; G06F 7/04

(52) U.S. Cl. 700/113; 340/5.7; 901/1; 901/49; 901/41

(57) ABSTRACT

Manufacturing equipment is provided for safely changing the setup of a jig while maintaining production line utilization. A safety wall prevents entry into a machining area where multiple machining installations are installed. Openable and closable access doors are provided for the machining installations. A workpiece holding tool is moved in the machining area conveys workpieces from one of the machining installations to another. Isolation walls prevent the movement of the workpiece holding tool. A control device drives the isolation walls allowing movement of the workpiece holding tool outside the machining area at the machining installation corresponding to an opened access door and prevents the workpiece holding tool from moving into the machining area with the opened access door.

### CROSS REFERENCE TO RELATED APPLICATIONS

The present applications is based on and claims priority to Japanese Patent Application No. 2007-264737, filed on Oct. 10, 2007, the entire contents of which are incorporated herein by reference.

### BACKGROUND OF THE INVENTION

1. Field of the Invention

The present invention relates to production line manufacturing equipment and more specifically to equipment to automatically convey and machine work pieces at multiple machining installations.

2. Description of Related Art

Conventional manufacturing equipment involving a jig setup change, includes a multi-spindle head replacement type machine tool, such as described in JP-A-2006-289577, including multiple multi-spindle heads movably fitted to an annular rail. When a workpiece is machined by driving a rotary tool by a machining unit, the multi-spindle heads not used for machining are separated from the machining unit side. The multi-spindle head replacement type machine tool includes a first main body having the machining unit and a second main body that is movable against the first main body by a driving source provided in the first main body. The annular rail can be divided into a first stationary rail mounted to the first main body and a second stationary rail mounted to the second main body.

As consumption behavior is diversified in recent years, the categories of products have also been diversified requiring increased automation. The increased requirement for automated production lines has increased the requirement for multiple types of workpieces to be conveyed and machined with multiple machining installations.

The jig on each machining installation can differ from workpiece to workpiece. When workpieces different in shape are conveyed and machined, a change in the setup of the jig on each machining installation is required according to the type of workpiece.

In the above described production line, a transfer robot moves in proximity to each machining installation to convey workpieces. Therefore, when a worker attempts to change the setup of a jig, a transfer robot can be brought into contact with the worker. One solution is to stop the transfer robot when the setup of a jig is changed. However, disadvantages arise in that when a transfer robot is stopped, the utilization rate is degraded.

### SUMMARY OF THE INVENTION

The invention has been made in consideration of foregoing and other factors. It is an object of the invention to provide manufacturing equipment for safely changing the setup of a jig can without degrading the utilization rate of the production line

To achieve the above object, manufacturing equipment used in a production line can be configured such that workpieces are automatically conveyed and machined with multiple machining installations having jigs corresponding to the shape of each workpiece. The manufacturing equipment includes a safety wall provided for each of the machining installations, the safety wall having an openable and closable access door that prevents the entry to a machining area where multiple machining installations are placed, a transfer robot moved in the machining area and capable of conveying workpieces from one machining installation to another, an isolation member that prevents the movement of a transfer robot, and a control device that drives an isolation member to allow the movement of a transfer robot outside the machining area at the machining installation corresponding to an opened access door and prevents a transfer robot from going into the machining area.

Even though a worker opens the access door and enters the machining area where a jig is replaced to change the setup of the jig on the machining installation, the above described equipment makes it possible to prevent the worker from being brought into contact with the transfer robot by use of the isolation member. Therefore, the safety of the worker who changes the setup of a jig can be enhanced. Further, since a transfer robot is movable outside the machining area, the degradation in the utilization rate of the production line can be prevented.

In accordance with the invention, a transfer robot may be suspended from a rail provided above multiple machining installations and moved along the rail.

The above described equipment generates a desirable effect in that it unnecessary to provide an extra mechanism for a transfer robot between an access door and a machining installation.

The isolation member may be constructed as an isolation wall that isolates one machining installation from another when the movement of a transfer robot is prevented.

The foregoing makes it possible to reliably prevent a transfer robot from entering the machining area at the machining installation corresponding to an opened access door.

The isolation member may be provided with a protrusion protruding in parallel with the rail and perpendicular to the direction of the movement of the transfer robot.

The above described equipment also makes it possible to reliably prevent a transfer robot from entering the machining area at the machining installation corresponding to an opened access door.

An instruction device is provided that can be operated by a worker and that outputs a request signal requesting a permission to open an access door and enter the machining area where a machining installation is placed. When a request signal is outputted, the control device moves the transfer robot out of the machining area at the machining installation corresponding to information contained in the request signal and further prevents the movement of the transfer robot into the machining area by an isolation member. The control device thereafter allows the access door to be opened.

When the access door is opened, as a result of the isolation of the transfer robot by the isolation member, the safety of a worker who changes the setup of a jig can be further enhanced.

### BRIEF DESCRIPTION OF THE DRAWINGS

Other objects, features and characteristics of the present invention will be appreciated and become apparent to those of ordinary skill in the art and all of which form a part of the present application. In the drawings:

FIG. 1 is a diagram illustrating a general configuration of a production line to which manufacturing equipment of an embodiment of the invention is applied;

FIG. 2 is a diagram further illustrating a general configuration of the interior of a production line to which manufacturing equipment of an embodiment is applied;

FIG. 3 is a diagram illustrating a general configuration of a workpiece holding tool in a production line to which manufacturing equipment of an embodiment is applied;

FIG. 4 is a diagram illustrating a side view of a general configuration of a production line to which manufacturing equipment of an embodiment is applied;

FIG. 5 is a diagram illustrating a front view of a general configuration of a production line to which manufacturing equipment of an embodiment is applied;

FIG. 6 is a diagram illustrating a top view of a general configuration of a production line to which manufacturing equipment of an embodiment is applied;

FIG. 7A is a diagram illustrating exemplary operational flow of manufacturing equipment of an embodiment;

FIG. 7B is a diagram further illustrating exemplary operational flow of manufacturing equipment of an embodiment;

FIG. 7C is a diagram further illustrating exemplary operational flow of manufacturing equipment of an embodiment;

FIG. 7D is a diagram further illustrating exemplary operational flow of manufacturing equipment of an embodiment;

FIG. 7E is a diagram further illustrating exemplary operational flow of manufacturing equipment of an embodiment;

FIG. 7F is a diagram further illustrating exemplary operational flow of manufacturing equipment of an embodiment; and

FIG. 8 is a diagram illustrating the general configuration of an isolation member in a modification to an embodiment.

### DETAILED DESCRIPTION OF THE EXEMPLARY EMBODIMENTS

Hereafter, description will be given to embodiments of the invention with reference to drawings.

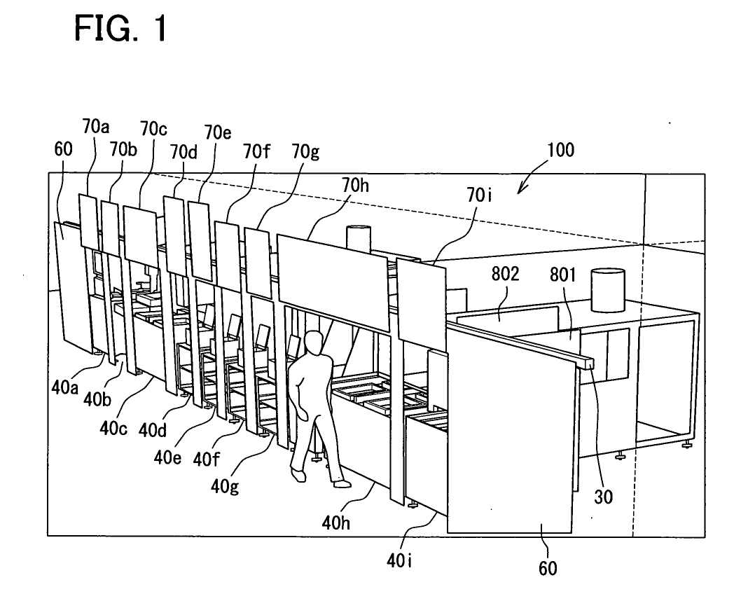

As illustrated in FIG. 1, the manufacturing equipment of the present embodiment is applied to a production line 100 configured such that workpieces 200 are automatically conveyed and are machined with multiple machining installations 40a to 40i having a jig 50 corresponding to the shape of each of the workpieces 200. That is, the manufacturing equipment is applied to a production line 100 for machining workpieces 200 including printed boards, circuit boards obtained by mounting a circuit component over a printed board, and the like. Specifically, the manufacturing equipment includes a safety wall 60 having access doors 70a to 70i, a workpiece holding tool 10, acting as a transfer robot, isolation walls 801, 802, acting as isolation members, and a control device 90.

The production line 100 is provided with multiple machining installations 40a to 40i that are provided for performing the respective steps of machining workpieces 200. The production line 100 includes workpiece conveying equipment for conveying workpieces 200 to each of the machining installations 40a to 40i. In the description of the present embodiment, a case where the machining installations 40a to 40i are substantially linearly disposed will be taken as an example. Each of the machining installations 40a to 40i is provided with a jig 50 on which a workpiece 200 is placed. Each jig 50 has a shape corresponding to the workpiece shape or outside shape of each workpiece 200. When workpieces different in workpiece shape or outside shape are placed, it is required to replace jigs. The foregoing is referred to as setup change. The workpiece conveying equipment includes a workpiece holding tool 10 driven and controlled by the control device 90, a rail 30 for moving the workpiece holding tool 10, and the like.

Overhead above each of the machining installations 40a to 40i, a support beam is provided for supporting or suspending a workpiece holding tool 10, acting as a transfer robot, for holding and conveying a workpiece 200. More specifically, the support beam is provided above, more specifically, overhead above the jigs 50a to 50f respectively provided for the machining installations 40a to 40i. On the side of the support beam facing toward the machining installations 40a to 40i, that is, in the direction of weight, the rail 30, which supports the workpiece holding tools 10, is provided so that the workpiece holding tools are movable throughout in the direction of the length of the support beam.

The support beam and the rail 30 are provided to extend between one end and the other end of a line along which the multiple machining installations 40a to 40i are disposed. The support beam and the rail 30 extend continuously through and above all the machining installations 40a to 40i. As a result, the workpiece holding tools 10 can be moved to all the machining installations 40a to 40i. The workpiece holding tools 10 are moved by, for example, a linear motor while being suspended from the rail 30, which may also referred to as a linear motor-driven rail.

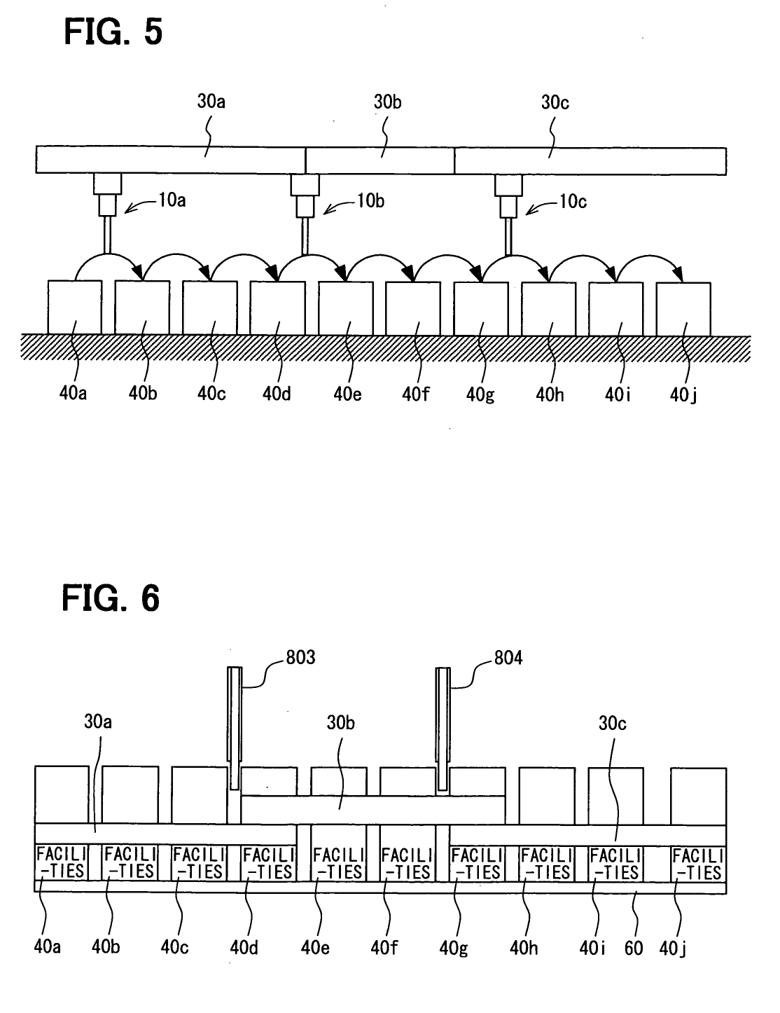

The rail 30 is long to the extent that the rail can be easily fabricated and installed. For example, the rail is 3 to 5 m long. In cases where the overall length of a line is larger than the length of the rail 30, rails 30a, 30b, 30c may be joined together, for example as illustrated in FIG. 5, FIG. 6, when used. When multiple rails 30a, 30b, 30c are joined together and used, the rails can be disposed as illustrated in FIG. 5 and FIG. 6. That is, the rails are disposed so that at least two rails, the rail 30a and the rail 30b or the rail 30b and the rail 30c, partly overlap each other above at least one of the machining installations 40a to 40i. In the present embodiment, rails partly overlap each other above the machining installations 40d, 40g.

As the result of the above construction, a workpiece 200 present at a machining installation, for example, the machining installations 40d, 40g positioned at an end of a rail can be held and conveyed by the workpiece holding tool 10 suspended from another rail. Therefore, it is unnecessary to use a rail long enough to correspond to the overall length of the multiple machining installations 40a to 40i. Further, it is also unnecessary to provide a feeding device or the like for sliding a workpiece 200 to a position corresponding to an end of a rail. Therefore, workpieces can be conveyed throughout the entire multiple machining installations without providing a feeding device or the like for sliding workpieces.

By way of example, a workpiece 200 is conveyed to the machining installation 40d by the workpiece holding tool 10 suspended from the rail 30a. The workpiece 200 is conveyed from the machining installation 40d to the machining installation 40g by the workpiece holding tool 10 suspended from the rail 30b. Further, a workpiece 200 is conveyed to the machining installation 40g by the workpiece holding tool 10 suspended from the rail 30b. The workpiece 200 is conveyed from the machining installation 40g to the machining installation 40i by the workpiece holding tool 10 suspended from the rail 30c.

In the production line 100 to which the manufacturing equipment of the present embodiment is applied, the machining area where the multiple machining installations 40a to 40i are disposed and a peripheral area through which a worker can pass are isolated from each other by the safety wall 60. The safety wall 60 is provided with access doors 70a to 70i that can be opened and closed in the vertical direction for the respective machining installations 40a to 40i. That is, the safety wall 60 prevents a worker from entering the machining area. The opening and closing of the access doors 70a to 70i is controlled by a lock applied or released under the control of the control device 90. As a result, the access doors 70a to 70i can be opened when work, such as jig 50 setup change, is carried out in the machining area and cannot be opened when machining operation is in progress at the machining installations 40a to 40i.

As mentioned above, the setup of the jigs 50 provided on the multiple machining installations 40a to 40i must be changed according to the workpiece shape of each workpiece 200. As illustrated in FIG. 4, FIG. 5, and the like, the workpiece holding tools 10 are moved above the jigs 50 in the above-mentioned machining area. When a worker is to manually change the setup of a jig 50, the worker must enter the machining area or put part of the body of the worker into the machining area. When a worker is working at jig 50 setup change, therefore, the worker can be brought into contact with a workpiece holding tool 10.

To avoid potential dangers with entry into the area, all the production at the production line 100 is completed and the workpiece holding tools 10 are stopped; and the setup of the entire production line 100 is changed. When the above described method is implemented, however, the production line 100 is stopped for a time equivalent to the sum of the machining lead time of the entire production line 100 and the time required for setup change.

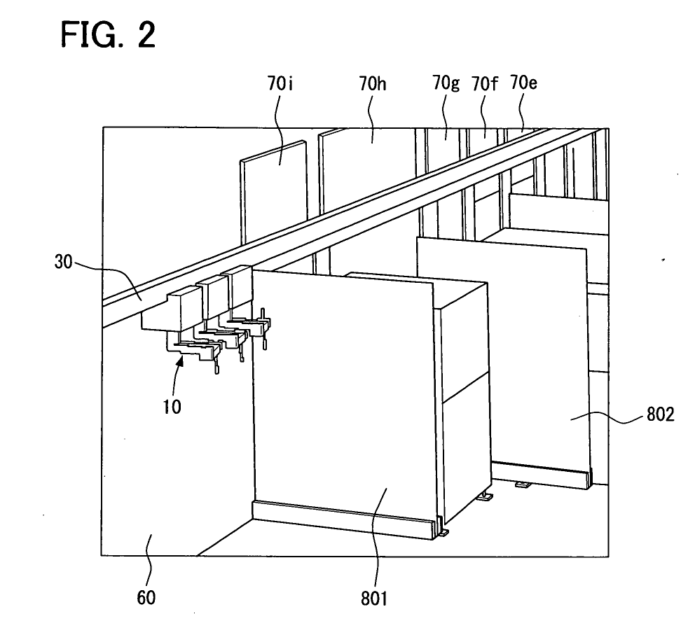

In the present embodiment, in order to make it possible to change the setup of a jig 50 in safety without degrading the utilization rate of the production line 100 isolation walls, or isolation members, 801, 802, the isolation walls 801, 802 are automatically moved by an actuator or the like and prevent the movement of workpiece holding tools 10 movable in the machining area. As illustrated in FIG. 2, the isolation wall 801, 802 may be provided in each boundary between machining installations 40a to 40i. Or, as illustrated in FIG. 6, an isolation wall may be provided for every multiple machining installations. FIG. 6 illustrates a case where isolation walls 803, 804 are provided to divide the production line 100 into three and setup change is dividedly carried out.

The isolation walls 801, 802 are driven and controlled by the control device 90 described later. The isolation walls 801, 802 implement the following. The movement of a workpiece holding tool 10 outside the machining area at the machining installation corresponding to an opened access door is allowed. The above machining installation is any of the machining installations 40a to 40i and the above opened access door is any of the access doors 70a to 70i. At the same time, the movement of a workpiece holding tool 10 into the machining area at the machining installation corresponding to the opened access door is prevented.

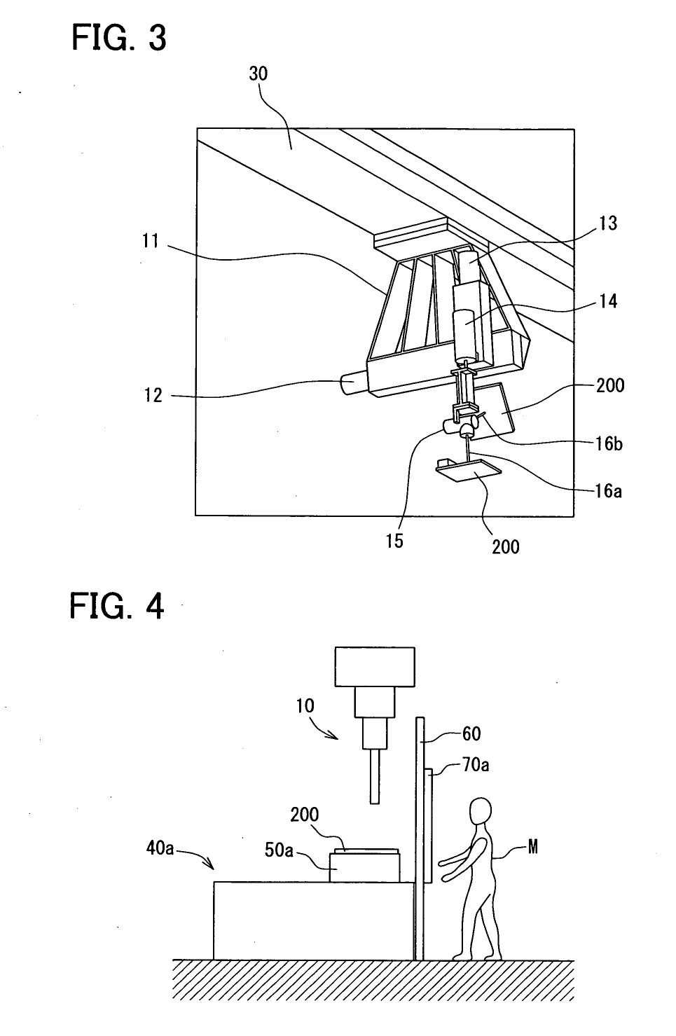

Description will be given to the workpiece holding tool 10, acting as the transfer robot. As illustrated in FIG. 3, the workpiece holding tool 10 includes a support portion 11, a Y-axis adjusting portion 12, a Z-axis adjusting portion 13, a θ-axis adjusting portion 14, a base member 15, arm 16a, and arm 16b. The support portion 11 is provided with the Y-axis adjusting portion 12, Z-axis adjusting portion 13, θ-axis adjusting portion 14, base member 15, and arm 16a, and arm 16b that construct a workpiece holding tool 10. The support portion 11 includes a drive unit, not shown, suspended from the rail 30 so that the drive unit is movable.

The Y-axis adjusting portion 12 includes an actuator and the like and adjusts the arms 16a, 16b in the Y-axis direction. The Y-axis direction is a direction parallel with the ground and perpendicular to the direction of conveyance of workpieces 200. The Y-axis adjusting portion 12 adjusts the arms 16a, 16b in the Y-axis direction according to an instruction from the control device, not shown.

The Z-axis adjusting portion 13 includes an actuator and the like and adjusts the arms 16a, 16b in the Z-axis direction. The Z-axis forms the third axis in a three-dimensional coordinate system. In the present example, the Z-axis direction is perpendicular to the ground. That is, the Z-axis adjusting portion 13 moves the arms 16a, 16b in the direction perpendicular to the ground and thereby moves a workpiece 200 close to or away from a machining installation 40a to 40b. In other words, the Z-axis adjusting portion 13 moves the arms 16a, 16b up and down. The Z-axis adjusting portion 13 adjusts the arms 16a, 16b in the Z-axis direction according to an instruction from the control device, not shown.

The θ-axis adjusting portion 14 includes an actuator and the like and adjusts the arms 16a, 16b in the theta-axis direction. The theta-axis direction is a direction in which something is rotated with the direction perpendicular to the ground taken as the rotation axis. That is, the θ-axis adjusting portion 14 rotates the arms 16a, 16b with the direction perpendicular to the ground taken as the rotation axis. The θ-axis adjusting portion 14 adjusts the arms 16a, 16b in the theta-axis direction according to an instruction from the control device, not shown.

The base member 15 is provided with the two arms 16a, 16b opened at a predetermined angle therebetween and includes a rotating mechanism, also acting as a switching mechanism, constructed of an actuator and the like. The base member 15 is rotated on a line along the direction of the conveyance of workpieces 200 by the rotating mechanism. That is, the base member 15 is rotated on a line along the direction of the conveyance of workpieces 200 with the two arms 16a, 16b supported thereby. In other words, the base member 15 is rotated on the rotation axis parallel to the ground and perpendicular to the direction of the conveyance of workpieces 200 by the rotating mechanism. The arm 16a and the arm 16b are provided on the base member 15 as are opened at the predetermined angle therebetween with the rotation axis at the center.

In the present embodiment, as mentioned above, the base member 15 is rotated by the rotating mechanism and the arm 16a and the arm 16b are thereby switched. That is, the rotating mechanism switches the arm 16a or 16b that holds and picks up a workpiece 200 from a machining installation 40a to 40i. At the same time, the rotating mechanism switches the arm 16a or 16b that places a held workpiece 200 on a machining installation 40a to 40i. Switching the arm 16a and the arm 16b means switching which arm, the arm 16a or the arm 16b, should be disposed in a position facing toward a jig 50a to 50f or the workpiece 200 placed on a jig 50a to 50f. The two arms 16a, 16b may be so provided that the arms can be attached to and detached from the base member 15.

The arm 16a and the arm 16b hold and place a workpiece 200 independently of each other. Each arm may be so constructed, for example, that a cylindrical member is brought into contact with a workpiece 200 and the workpiece is vacuum-chucked or a workpiece 200 is clamped. In cases where a workpiece 200 has a hole, each of the arms 16a, 16b may be so constructed that the arm holds the workpiece 200 by being inserted into the hole. That is, each arm may be so constructed that the following is implemented. The arm is to be inserted into a hole in a workpiece 200. The arm includes: an inner pipe having a cylindrical portion extended in the direction of the axis of the hole and split portions obtained by splitting an end of the cylindrical portion into multiple pieces; and a rod member having a protrusion smaller than the opening width of the hole and larger than the opening width of the inner pipe. Before the inner pipe and the rod member are partly inserted into the hole, the protrusion is disposed outside the inner pipe. After the inner pipe and the rod member are partly inserted into the hole, the rod member is moved in the direction opposite the direction of insertion. As a result, the protrusion is disposed in the inner pipe and the split portions are pushed open and the workpiece 200 is held by the split portions. As mentioned above, printed boards and circuit boards adopted as workpieces 200 often have a hole. Even though a printed board or a circuit board does not have a hole, it is relatively easy to form a hole in the board. That is, forming a hole in a printed board or a circuit board will rarely pose a problem in terms of design or function.

The foregoing makes it possible to simultaneously hold different workpieces 200 by the two arms 16a, 16b. It is also possible to hold one workpiece by one arm, for example, the arm 16a and place a workpiece 200 by the other arm, for example, the arm 16b. Therefore, a workpiece 200 on any of the machining installations 40a to 40i can be held by one arm, for example, the arm 16a and a workpiece 200 held by the other arm, for example, the arm 16b is placed on that machining installation. As a result, the stop time at the machining installations 40a to 40i can be shortened.

The above described construction makes it possible to rotate the base member 15 to rotate the two arms 16a, and 16b on a line along the direction of the conveyance of workpieces 200 and thereby easily switch the arms 16a, and 16b.

A case where workpieces are conveyed between machining installations 40a to 40c can be described as an example. According to a conveyance diagram for the workpiece holding tool 10 and workpiece conveying equipment in the present embodiment, a workpiece 200 is first held and picked up from the installation 40a by the arm 16a of the two arms. The workpiece holding tool 10 is moved to the installation 40b as the next machining installation and the arm that is designated to hold a workpiece is then switched from the arm 16a to the arm 16b by the rotating mechanism. Another workpiece 200 is then held and picked up from the installation 40b by the arm 16b. The arm that that is designated to be used is then switched from the arm 16b back to the arm 16a by the rotating mechanism. The workpiece 200 is then held by the arm 16a is placed on the installation 40b. The workpiece holding tool 10 is then moved to the installation 40c as the next machining installation and another workpiece 200 is then held and picked up from the installation 40c by the arm 16a. The arm that should place a workpiece is switched from the arm 16a to the arm 16b by the rotating mechanism. The workpiece 200 held by the arm 16b is then placed on the installation 40c.

The operation can be alternately described as follows. A workpiece 200 is picked up by the arm 16a at the installation 40a and a shift if the workpiece 200 to the installation 40b is carried out. The arms are switched and another workpiece 200 is picked up from the installation 40b by the arm 16b, which is free. Thereafter, the arms are switched and the workpiece 200 held by the arm 16a is placed on the installation 40b, which then becomes operable. That is, the stop time at the installation 40b is equal to the sum of the time for moving up and down the workpiece holding tool 10 four times and the time for switching the arms. Therefore, the time for which a machining installation is stopped for changing workpieces can be shortened.

As described in relation to the present embodiment, the workpiece holding tool 10 is suspended from and moved along the rail 30 provided above the multiple machining installations 40a to 40i. The above described construction and operation is advantageous since it is thereby unnecessary to provide an extra mechanism for a robot conveying workpieces between the access doors 70a to 70i and the machining installations 40a to 40i.

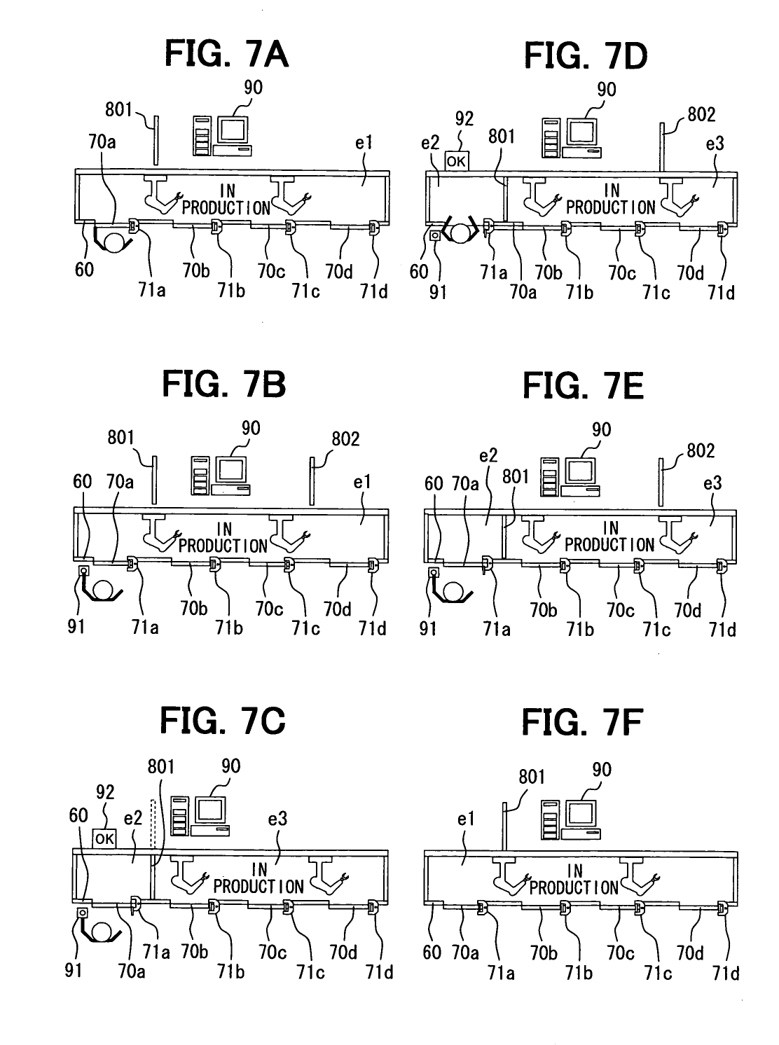

Description will be given to the operation of a work device in accordance with the present embodiment. With reference to FIG. 7A to FIG. 7F, only part of the production line 100, specifically, the portion of the production line at the four machining installations 40a to 40d, is depicted for ease of explanation. In the figures, the machining installations 40a to 40d are omitted and workpiece holding tools 10 are simplified.

FIG. 7A illustrates a state in which the production line 100 is in operation and machining at the machining installations 40a to 40d is in progress, and the workpiece holding tools 10 are in operation, that is, production is in progress. The area on the machining installation side, behind the safety wall 60, is all used as machining area e1. The locks 71a to 71d are applied and all the access doors 70a to 70d are closed and unopenable. As a result, a worker cannot enter the machining area, such as the workpiece holding tool moving area e1, and further is prevented from placing even a part of the body into the area either accidentally or intentionally since the access doors 70a to 70d cannot be opened.

FIG. 7B illustrates a state in which the worker operates the instruction device 91 when the production line 100 is in operation. The instruction device 91 is operated by workers and outputs a request signal to the control device 90. The request signal indicates a request for permission to open an access door and enter the machining area where the machining installations are installed. The instruction device 91 is provided for each access door. In the example illustrated in FIG. 7B, the instruction device 91 outputs a request signal associated with a request for permission to open the access door 70a and to enter the machining area where the machining installations are installed. The instruction device 91 may be provided for each of the areas divided when setup change is dividedly carried out, that is, the instruction device may be provided for each boundary between isolation walls. Or, only one instruction device is provided making it possible to select which access door to open is provided. As described in greater detail hereinafter, the instruction device 91 is also capable of outputting an end signal indicating the termination of work.

In order to ensure the safety of the worker in the machining area, FIG. 7C illustrates a state in which a workpiece holding tool 10 is moved out of the work area, such as the worker area e2, and the isolation wall 801 is closed and the lock 71a is released. The control device 90 moves the workpiece holding tool 10 out of the work area, such as the worker area e2, according to the signal from the instruction device 91. The control device drives and controls the isolation wall 801 to close the isolation wall 801 and further releases the lock 71a of the access door 70a. Thus, the work area e2 and the machining area e1 are separated from each other. The machining area e1 is where workpiece holding tools 10 are operated and machining is carried out at machining installations. The work area e2 is where a worker carries out divided setup changing work for a jig 50 or any other work. The access door 70a becomes openable and the worker can carry out setup changing work in safety in the work area e2.

The control device 90 may be so constructed that after the workpiece holding tool 10 is moved out of the work area, such as the worker area e2, and the isolation wall 801 is closed, the control device turns on a lamp 92 to inform the worker that it has been permitted to start the work. That is, workers are notified that divided setup changing work can be carried out in safety. As a result, when the access door 70a is opened, the workpiece holding tool 10 has been already moved out of the work area e2 without exception and the isolation wall 801 has been closed. Therefore, the safety of workers can be further enhanced.

FIG. 7D illustrates a state in which the worker has opened the access door 70a and is carrying out the divided setup changing work in the work area e2. As mentioned above, the work area e2 is separated or isolated from the machining area e1 by the isolation wall 801. Therefore, the worker cannot be brought into contact with the workpiece holding tool 10 and can carry out the work in safety.

FIG. 7E illustrates a state in which the work carried out in the work area e2 has been completed and the access door 70a has been closed and an end signal is outputted from the instruction device 91. When the setup changing work in the work area e2 is completed, the worker closes the access door 70a and operates the instruction device 91 to output an end signal.

When the end signal is outputted from the instruction device 91, the control device 90 detects whether or not the access door 70a has been closed as illustrated in FIG. 7F. When the access door 70a is closed, the control device applies the lock 71a of the access door 70a and opens the isolation wall 801. As a result, the entire area behind the safety wall 60 is returned to the machining area e1. The control device 90 moves the workpiece holding tool 10 to the area that was the work area e2, and resumes the workpiece conveying operation in the entire area.

As a result, safety in achieved even though a worker opens an access door 70a to 70i and enters the machining area to change the setup of the jig 50 on the corresponding machining installation 40a to 40i. The machining area is, in other words, established as the area behind the safety wall or the work area e2. The worker is prevented from being brought into contact with the workpiece holding tool 10 by the isolation wall 801. Therefore, the safety of a worker who changes the setup of a jig can be enhanced. Since the workpiece holding tool 10 is movable outside the work area e2, degradation in the utilization rate of the production line 100 can be prevented.

In the description of the present embodiment, a case where the isolation walls 801, 802 are adopted as the isolation member for preventing the movement of the workpiece holding tools 10 has been taken as an example however the invention is not limited to the present embodiment.

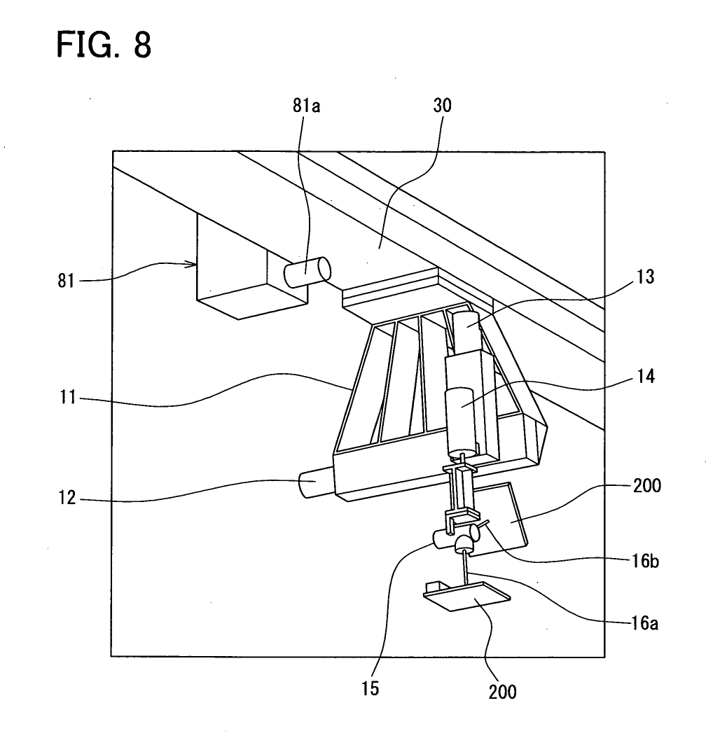

FIG. 8 illustrates the general configuration of an isolation member in a modification to the present embodiment of the invention. As illustrated in FIG. 8, the isolation member 81 is provided on the rail 30 from which a workpiece holding tool 10 is suspended. The isolation member includes a protrusion 81a that protrudes in parallel with the rail 30 and perpendicularly to the direction of the movement of the workpiece holding tool 10. That is, the isolation member 81 prevents the movement of the workpiece holding tool 10 by the protrusion 81a. The above described construction also makes it possible to reliably prevent the workpiece holding tool 10 from entering the machining area at the machining installation corresponding to an opened access door.

A light beam safety device may be used in place of the isolation walls 801, 802 or the isolation member 81 having the protrusion 81a. That is, the entry of a worker into the machining area is monitored by irradiating the machining area with a light beam. In such a case, a workpiece holding tool 10 is immediately stopped if the light beam is intercepted by a worker when the workpiece holding tool 10 is in operation.

A light beam safety device may further be used instead of providing the locks 71a to 71i of the access doors 70a to 70i. That is, the entry of a worker into the machining area is monitored by irradiating the machining area with a light beam. In such a case, a workpiece holding tool 10 immediately stopped if a light beam is intercepted by a worker when the workpiece holding tool 10 is in operation.

A mechanism for locking the isolation walls 801, 802 to prevent the isolation walls from being opened when an access door 70a to 70i is open may be provided. In such a case, the work area e2 can be ensured even though the control of the production line 100 runs away. Therefore, the safety of workers can be further enhanced.

What is claimed is:

1. An arrangement of manufacturing equipment used in a production line where workpieces are automatically conveyed and machined with a plurality of machining installations, each of the machining installations having a jig corresponding to a shape of the workpiece, the arrangement comprising:
a safety wall configured to prevent entry into a machining area where at least one of the plurality of machining installations is installed, access door provided for each of the plurality of machining installations, the access door capable of being placed into an openable condition and a closable condition;
a transfer robot movable in the machining area and capable of conveying the workpiece from one machining installation to another of the plurality of machining installations;
an isolation member for preventing the movement of the transfer robot; and
a control device driving the isolation member to allow the movement of the transfer robot outside the machining area at the at least one of the plurality of machining installations, the at least one corresponding to an opened one of the access door, the control device preventing the transfer robot from moving into the machining area.

2. The manufacturing equipment of claim 1,
wherein the transfer robot is suspended from a rail provided above the plurality of machining installations and is moved while suspended.

3. The manufacturing equipment of claim 1,
wherein the isolation member includes an isolation wall that, when the movement of the transfer robot is prevented, isolates one of the plurality of machining installations from another of the plurality of machining installations.

4. The manufacturing equipment of claim 2,
wherein the isolation member has a protrusion protruding in parallel with the rail and perpendicularly to the direction of the movement of the transfer robot.

5. The manufacturing equipment of claim 1, comprising:
an instruction device outputting a request signal requesting permission to open the access door and enter the machining area associated with the at least one of the plurality of machining installations,
wherein when the request signal is outputted, the control device moves the transfer robot out of the machining area and prevents the movement of the transfer robot into the machining area using the isolation member, and thereafter places the access door into the openable condition.

6. The manufacturing equipment of claim 1, comprising:
a plurality of instruction devices corresponding to and operated in connection with respective ones of the plurality of machining installations, one of the plurality of instructions devices corresponding to the at least one of the plurality of machining installations outputting a request signal requesting permission to open the access door and enter the machining area associated with the at least one of the plurality of machining installations,
wherein when the request signal is outputted, the control device moves the transfer robot out of the machining area and prevents the movement of the transfer robot into the machining area using the isolation member, and thereafter places the access door into the openable condition.
